(19) United States
(12) Patent Application Publication
(10) Pub. No.: US 2002/0178997 A1
(43) Pub. Date: Dec. 5, 2002

(54) Structure of a flag elevating/descending device

(76) Inventor: Yang Tsui-Hua, Taipei City (TW)

Correspondence Address: Tsui-Hua YANG, PO Box 82-144, Taipei, TW

(21) Appl. No.: 09/870,489

(22) Filed: Jun. 1, 2001

(51) Int. Cl. G09F 17/00

(52) U.S. Cl. 116/174

(57) ABSTRACT

An improved structure of a flag elevating/descending device is disclosed. The flagpole is provided with an elevating/descending tube and a rotating tube to allow the flag to elevate/descend and to rotate. An elevating/descending driving device is provided at the flagpole head, and a driving strap is protruded from the driving device to mount with the elevating/descending tube so that the driving strap can extend outward and/or roll up and the flag will not wind around the flagpole when the flag is elevated or descended. The base seat of the flagpole is provided with an un-interrupted current device and a re-storage battery so that the device is operable even if the current supply is cut off.

### BACKGROUND OF THE INVENTION

1. Field of the Invention

The present invention relates to an improved structure of a flag elevating/descending device, and in particular, a driving structure of the elevating/descending device having a driving strap to elevate and descend flag by rolling, allowing the flag in ascending/descending condition.

2. Description of the Prior Art

Convention flagpole has a pulley mounted at the top end of the flagpole and a rope passes through the pulley. A flag is then tied to the rope, and by pulling one end of the rope, the flag is either being pulled up or descended down. However, this method of ascending or descending the flag is inconvenient as the flag is fixed at one point and if wind is too strong, the flag will roll around the flagpole.

The applicant has exploited a device and a patent has been granted thereto with U.S. Pat. No. 6,155,018, entitled “STAFF STRUCTURE WITH A FLAG ELEVATING DEVICE” to mitigate the above drawback. However, the applicant has further improved the flagpole elevating/descending device to provide a more practical and useful flagpole elevating/descending device, which is simple in structure and convenient in operation.

### SUMMARY OF THE INVENTION

Accordingly, it is an object of the present invention to provide an improved structure of a flag elevating/descending device, wherein the flagpole is provided with an elevating/descending tube and a rotating tube, and both the tubes are mountable to each other, allowing the flag being elevated and rotated. Further, the head of the flagpole is provided with a flagpole elevating/descending driving device. A driving strap is provided to the driving device and is mounted together with the elevating/descending tube so that the driving device drives the driving strap to extend outward and to roll-up. Thus, in the course of flag being elevated or descended, the flag will not wind around the flagpole.

Yet another object of the present invention is to provide an improved structure of a flag elevating/descending device, wherein the base seat of the flagpole is provided with uninterrupted current device and a storage battery so that if current supply to the driving device is cut-off, the flagpole maintains operable to elevate or descend the flag.

The foregoing objective and summary provide only a brief introduction to the present invention. To fully appreciate these and other objectives of the present invention as well as the invention itself, all of which will become apparent to those skilled in the art, the following detailed description of the invention and the claims should be read in conjunction with the accompanying drawings. Throughout the specification and drawings, the same reference numerals refer to identical or similar parts.

Many other merits and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the elevating/descending device in accordance with the present invention.

FIG. 2 is a perspective exploded view of the device in accordance with the present invention.

FIG. 3 is a sectional view of the device in accordance with the present invention.

FIG. 4 is a sectional view showing the driving device mounted with the flagpole head in accordance with the present invention.

FIG. 5 is another elevational view of the driving device mounted with the flagpole head in accordance with the present invention.

### DETAILED DESCRIPTION OF THE PRESENT INVENTION

For the purpose of promoting the understanding of the principles of the invention, reference will now be made to the embodiment illustrated in the drawings. Specific language will be used to describe same. It will, nevertheless, be understood that no limitation of the scope of the invention is thereby intended. Alterations and further modifications in the illustrated device, and further applications of the principles of the invention as illustrated herein are contemplated as would normally occur to one skilled in the art to which the invention relates.

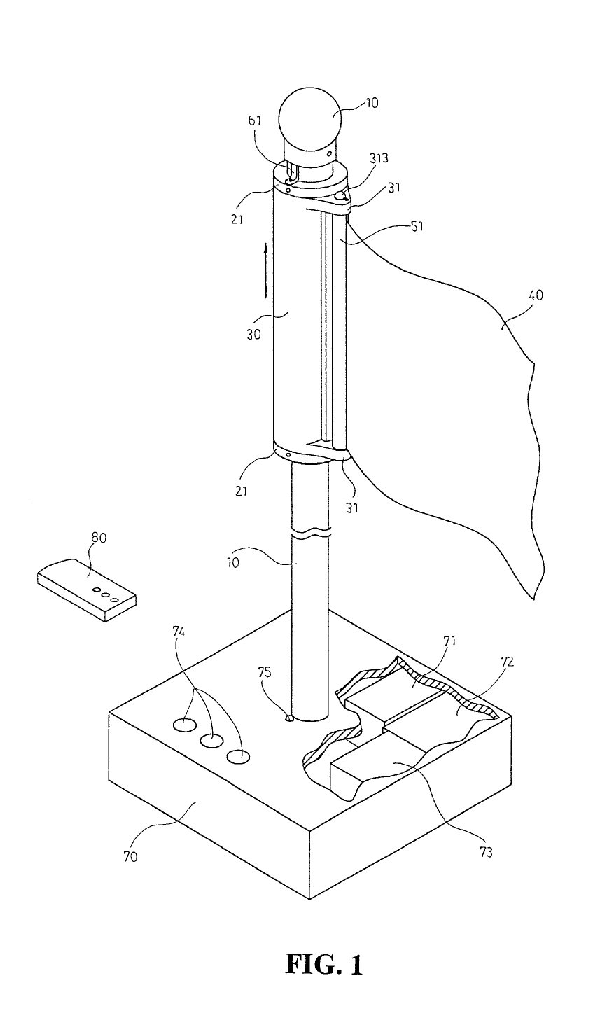

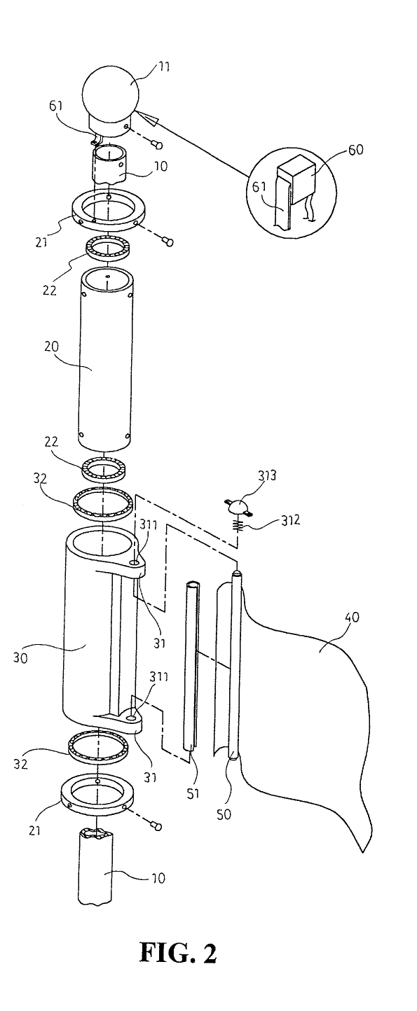

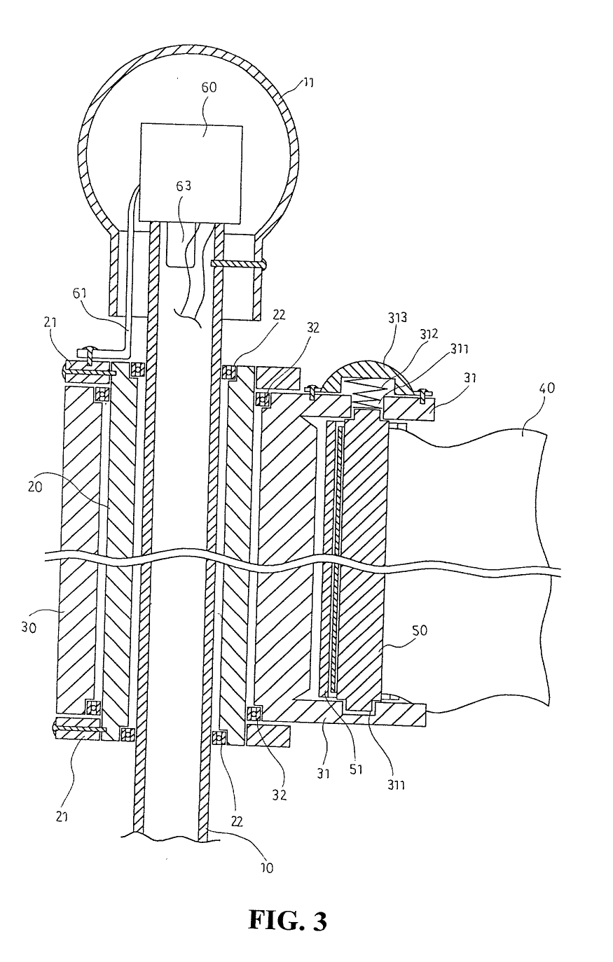

Referring to FIGS. 1 to 3, there is shown an elevating/descending tube 20 mounted onto a flagpole 10. A rotating tube 30 having a top and bottom end being provided with a protruded edge 31 is positioned around the rotating tube 30, and is used to hold a flag 40. The top and bottom ends of the elevating/descending tube 20 are provided with a blocking seat so that the rotating tube 30 is secured to the elevating/descending tube 20. The blocking seat 21 allows the rotating tube 30 to only rotate about the elevating/descending tube 20 without falling down. That is, the wind blowing to the flag 40 will cause the rotating tube 30 to rotate, and therefore, the flag 40 will not wind round the flagpole 10.

Further, the inner sidewall of the elevating/descending tube 20 and the rotating tube 30 is provided with bearings 22, 32 to lower the frictional force between the joint of the pole 10 and the elevating/descending tube 20 and the rotating tube 30. The two protruded edges 31 are provided with a hole seat 311 such that the top and the bottom end of the flag 50 can be inserted therein. The top of the hole seat 311 is provided with an elastic element 312 to urge a flag rod 50, which holds the flag 40. The top of the hole seat 311 is provided with a cover 313 so that the top and bottom end of the flag rod 50 are kept away from water entering into the hole seat 311. The flag rod 50 is provided with amounting chip 51 so as to mount the flag 40.

The flagpole head 11 of the flagpole 10 is mounted on the top end of the flagpole 10 with securing elements (for instance, screws) and an appropriate gap is maintained. The interior of the head 11 and the top edge of the flagpole 10 are mounted with a flag elevating/descending driving device 60 having a driving strap 61 which can be extended outward or rolled upward. One end of the driving strap 61 is extended out from the flag head 11 and is combined with the elevating descending tube 20. Thus, the driving of the driving device 60 allows the elevating/descending tube 20 to move upward or downward along the flagpole 10. The power source of the driving device 60 is supplied from the base seat 70 located at the bottom of the flagpole 10. A remote control/receiving circuit 71, an un-interrupted current device 72 and a storage battery 73 are provided to the base seat 70. Thus, a controller 80 is used to control the elevating/descending of the flag 40.

If power supply to the driving device is cut off, the storage battery 73 and the un-interrupted current device 72 will continue to provide power supply, without causing a halt to the elevating/descending of the flag 40.

In operation, a plurality of buttons 74 on the remote controller 80 or the base seat 70 are used to control the elevating/descending of flag or the power switching of the elevating/descending device. When the driving strap 61 is extended out, the elevating/descending tube 20 moves downward along the flagpole 10 so that the flag 40 is descending. The downward movement of the elevating/descending tube 20 to the base seat 70 will touch the micro-touch switch 75 and it will automatically stop. If the driving strap 61 is rolled into the driving device 60, the elevating/descending tube 20 will move upward so that the flag 40 is elevating.

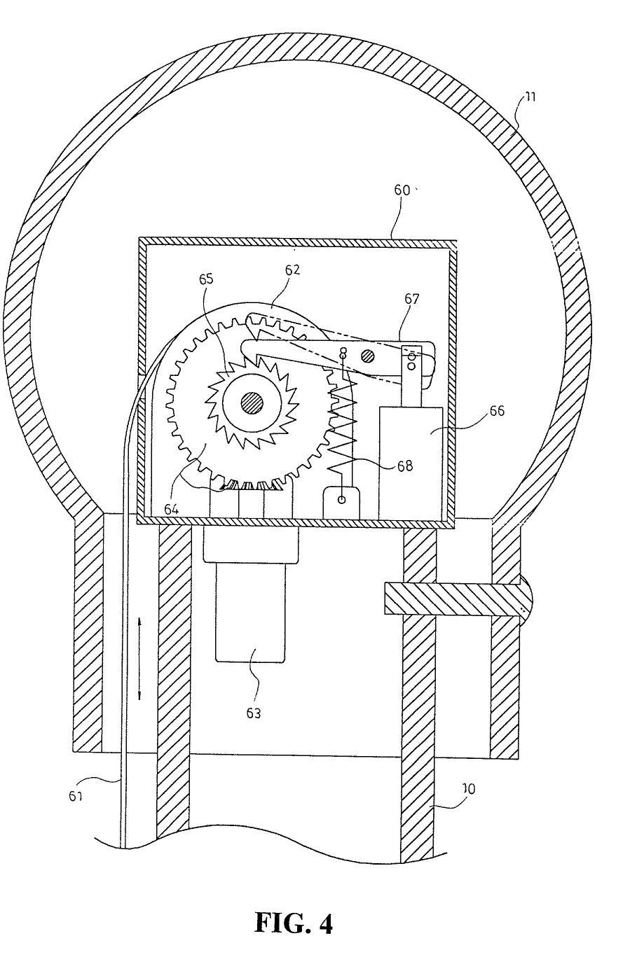

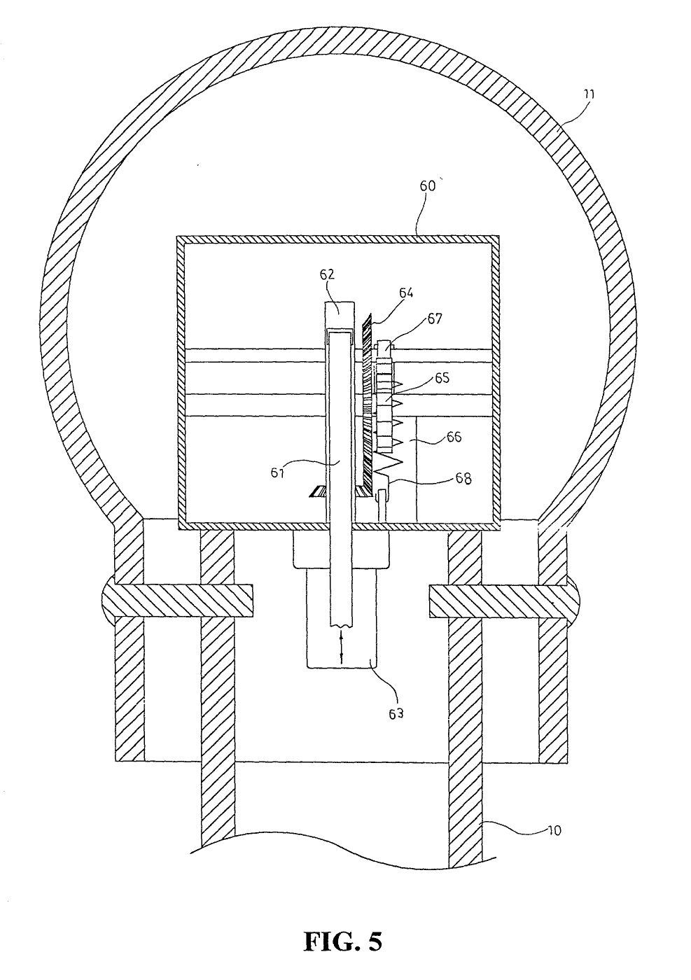

Referring to FIGS. 4 and 5, the driving device 60 is provided with a holding box 62, which is used to accommodate the driving strap 61, a motor 63 having a gear module 64, the driving of the gear module 64 causing the driving strap 61 to extend outward and to roll up. A ratchet wheel 65 is provided to the gear module 64 so that the engaging rod 67 of a battery valve 66 is engaged with the ratchet wheel 65. When the motor 63 is in operation, the battery valve 66 causes the engaging rod 67 to retract and move upward to dislocate from the engagement without deterring the gear module. If the power supply to the motor 63 is cut off, owing to the elasticity of the elastic element 68, the engaging rod 67 will automatically engage with the teeth of the ratchet wheel 65, so that the ratchet wheel 65 cannot be rotated in one direction. As a result, under normal condition, the driving strap 61 will not descend due to the weight of the elevating device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a flag elevating/descending device for a flagpole comprising
(a) an elevating/descending tube, mounted onto the flagpole, having a blocking seat at the top and bottom end thereof to restrict the dislocation of a rotating tube mounted to the elevating/descending tube;
(b) the rotating tube being mounted to the elevating/descending tube having provided with a protruded edge at the top and bottom end for mounting a flag thereto, the two protruded edges being provided with a hole seat allowing the top and bottom end of the flagpole to be inserted therein, a mounting clip being provided to clip the flag to a flag rod;
(c) a flag elevating/descending driving device mounted at the head of the flagpole allowing a driving strap to extend outward or to roll up;
(d) a base seat being mounted at the bottom of the flagpole having a remote control receiving circuit, uninterrupted current device and a storage battery therein;
thereby the driving strap of the driving device provides an extension or rolling up action to allow the flag to elevate/descend.

2. The improved structure of a flag elevating/descending device of claim 1, wherein a plurality of bearings are provided to the inner lateral wall of the elevating/descending tube and the rotating tube to reduce frictional force between the joints of the elevating/descending tube, the rotating tube and the flagpole.

3. The improved structure of a flag elevating/descending device of claim 1, wherein the hole seat is mounted with an elastic element, and a cover is provided to the top of the hole seat.

4. The improved structure of a flag elevating/descending device of claim 1, wherein a holding box is provided to the driving device to accommodate the driving strap, and the bottom of the driving device is a motor having a gear module, allowing the driving strap to extend outward or to roll up, and the gear module is provided with a ratchet wheel to engage with the front end of the engaging rod of a battery valve, such that when the motor is in operation the battery valve causes the engaging rod to retract and to move up to dislocate from engagement.

5. The improved structure of a flag elevating/descending device of claim 1, wherein the base seat is provided with a plurality of controlling buttons.

6. The improved structure of a flag elevating/descending device of claim 1, wherein a mounting clip is used to secure the flagpole head to the top end of the flagpole and maintains a gap therebetween.
